(19) United States
(12) Patent Application Publication
(10) Pub. No.: US 2025/0381093 A1
(43) Pub. Date: Dec. 18, 2025

(54) MASSAGE DEVICE

(71) Applicant: Dongguan Mimao Electronic Technology Co, Ltd., Dongguan (CN)

(72) Inventors: Xike HE, Dongguan (CN); Qinling WANG, Dongguan (CN)

(21) Appl. No.: 19/240,119

(22) Filed: Jun. 17, 2025

(30) Foreign Application Priority Data
Jun. 17, 2024 (CN) 202421388623.6
Jun. 6, 2025 (CN) 202521161002.9

(51) Int. Cl. A61H 19/00

(52) U.S. Cl. CPC A61H 19/40; A61H 2201/1215; A61H 2201/1418

(57) ABSTRACT

A massage device includes a housing and a swing unit, the housing includes a surrounding wall forming a cylindrical structure and two opposite openings respectively passing through the surrounding wall on opposite sides of the housing, and the swing unit includes: a swing section having a first swing end and a second swing end protruding from the two openings to the outside of the housing respectively; a motor; and a driving mechanism coupled to the motor and converting a rotational motion of the motor into a swing motion of the swinging section; wherein the first swing end and the second swing end swing back and forth with respect to the housing along an extending direction of the housing, and the first swing end and the second swing end alternately swung. According to the present disclosure, a massage device capable of being miniaturized and having a compact structure can be provided.

### CROSS-REFERENCES TO RELATED DISCLOSURES

This disclosure claims the benefit of priority to Chinese Patent Disclosure Number 202421388623.6 filed on Jun. 17, 2024 and Chinese Patent Disclosure Number 202521161002.9 filed on Jun. 6, 2025, in the China National Intellectual Property Administration. The entire contents of the above-identified disclosure are hereby incorporated by reference.

### FIELD OF THE INVENTION

This present disclosure relates to a massage device for massaging a part of a human body (including but not limited to body cavity, such as vagina).

### BACKGROUND

Since existing driving modules for massaging devices require complex internal structures to transform a motion direction of an output shaft of a motor which need to occupy a large space, it cannot meet different size requirements of the massaging devices. It would be desirable to have a driving module capable of being miniaturized and having a compact structure.

### BRIEF DESCRIPTION OF THE DRAWINGS

FIG. 1 is a perspective view of a massage device according to an Embodiment 1 of the present disclosure.

FIG. 2 is a sectional view illustrating a configuration of a swing member of the massage device according to the Embodiment 1 of the present disclosure.

FIG. 3 is an exploded view of the massage device according to the Embodiment 1 of the present disclosure.

FIG. 4 is a schematic view showing a protruding portion of the swing member of the massage device according to the Embodiment 1 of the present disclosure.

FIG. 5 is an exploded view illustrating the swing member of the massage device of the Embodiment 1 of the present disclosure.

FIG. 6 is a schematic view illustrating the swing member of the massage device of the Embodiment 1 of the present disclosure is located at a swing position.

FIG. 7 is a schematic view illustrating the swing member of the massage device according to the Embodiment 1 of the present disclosure is located at another swing position.

FIG. 8 is a perspective view of a massage device according to a Embodiment 2 of the present disclosure.

FIG. 9 is a sectional view illustrating one swing position of the swing member of the massage device according to the Embodiment 2 of the present disclosure.

FIG. 10 is a sectional view illustrating another swing position of the swing member of the massage device according to the Embodiment 2 of the present disclosure.

FIG. 11 is a perspective view of a massage device according to an Embodiment 3 of the present disclosure.

FIG. 12 is a sectional view illustrating one swing position of the swing member of the massage device according to the Embodiment 3 of the present disclosure.

FIG. 13 is a sectional view illustrating another swing position of the swing member of the massage device according to the Embodiment 3 of the present disclosure.

FIG. 14 is a side view of a massage device according to an Embodiment 4 of the present invention.

FIG. 15 is a sectional view illustrating one swing position of the swing member of the massage device according to the Embodiment 4 of the present disclosure.

FIG. 16 is another sectional view of the massage device in the Embodiment 5 of the present disclosure.

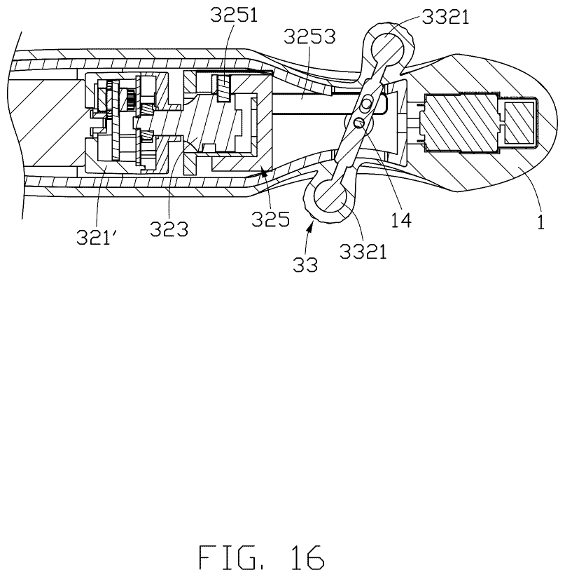

FIG. 17 is a side view of a massage device according to an Embodiment 5 of the present disclosure.

FIG. 18 is a sectional view illustrating one swing position of the swing member of the massage device according to the Embodiment 5 of the present disclosure.

FIG. 19 is a sectional view illustrating another swing position of the swing member of the massage device according to the Embodiment 5 of the present disclosure.

FIG. 20 is a view illustrating a driving module of the massage device in the Embodiment 5 of the present disclosure.

FIG. 21 is a sectional view of a massage device according to an Embodiment 6 of the present disclosure.

### DETAILED DESCRIPTION

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments in the present disclosure, all other embodiments obtained by ordinary technicians in this field without creative work are within the scope of protection of this disclosure.

### Embodiment 1

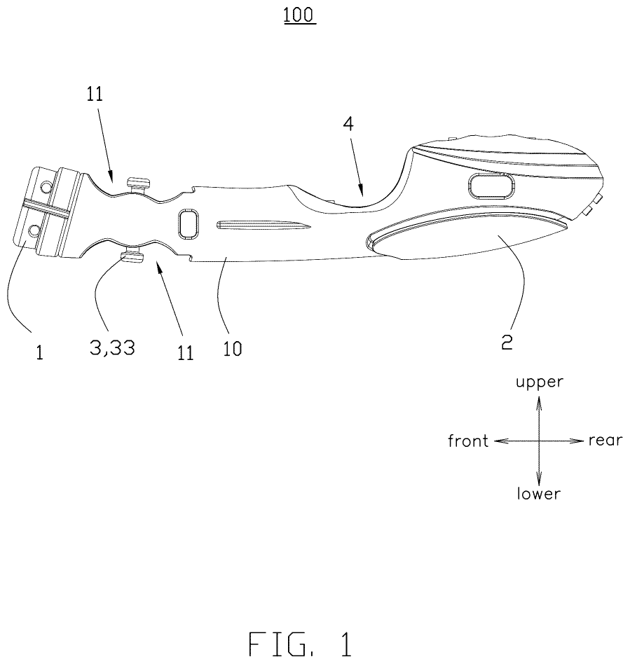

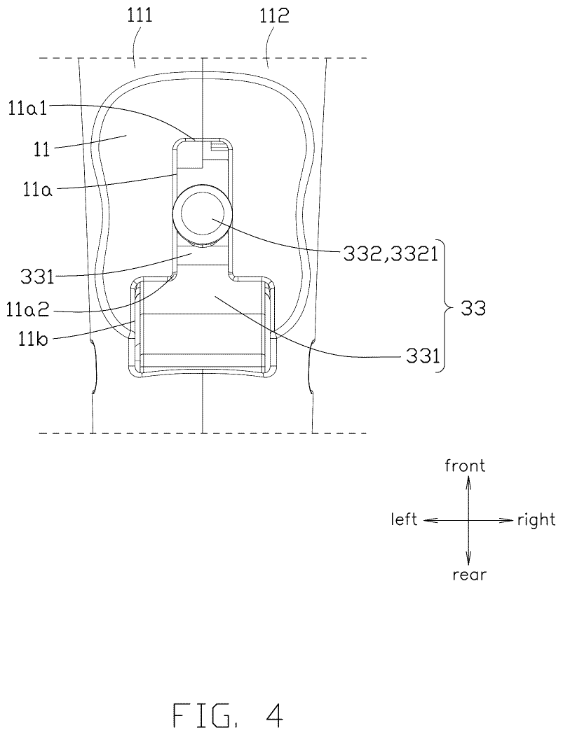

With reference to FIGS. 1-4, a configuration of a massage device 100 according to an Embodiment 1 of the present disclosure is described below. The massage device 100 is suitable for massaging different portions of a human body. In some embodiments of the present disclosure, the massage device can be for example an adult product which is used for stimulating vaginas of women.

The driving module 100 includes a housing 10 and a swing unit 3 accommodated in the main housing 10. In addition, an outer surface of the housing 10 is mostly coated with a coating layer which is made by an elastic material (not shown). The elastic material may be silicone, rubber, or other elastic substances.

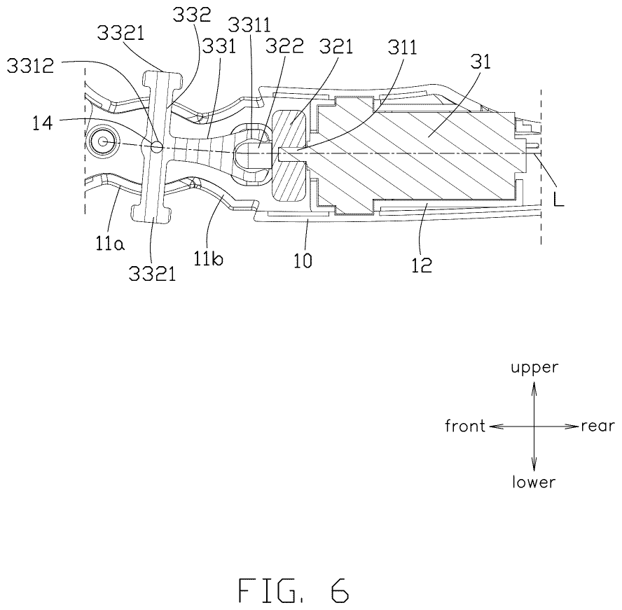

The housing 10 extends in an elongated strip shape along an axis L (Referring to FIG. 6), the axis L is arranged approximately along a front-rear direction, and the axis L as a whole may be a straight line with a constant slope, or may include two or more straight lines with different slopes, or may also include a curve.

In some embodiments of the present disclosure, the housing 10 is preferably assembled from a first housing portion 111 and a second housing portion 112 which are detachably mounted together, thereby facilitating the installation of internal components. In addition, the housing 10 may also be integrally formed as long as internal components can be installed. A front end 1 of the housing 10 may be configured to connect a top head (not shown) and a vibration unit (not shown). The rear end 2 of the main housing 10 may function as a handle.

The housing 10 is provided with a moving space M adjacent to the front end. The swing unit 3 is swingable in the moving space along an extending direction (a front-rear direction) of the moving space M. The moving space M penetrates the housing 10 along a thickness direction of the housing 10, and correspondingly forms two opposite openings 11a at opposite sides of the housing 10, for example the upper and lower sides or the rear and left sides. The orthographic projections of the two openings 11a on a longitudinal section of an internal space defined by the housing 10 partially or fully overlap, so as to make the internal space to be in air communication with an external environment outside of the housing 10 via each opening 11a. The swing unit 3 partly extends out of the housing 10 through the openings 11a. In some embodiments of the present disclosure, the first housing portion 111 includes a first upper edge and a first lower edge located at upper and lower sides of the first housing portion 111, as well as a first notch and a second notch respectively formed in the first upper edge and the first lower edge. The second housing portion 112 includes a second upper edge and a second lower edge located at upper and lower sides of the second housing portion 112, as well as a third notch and a fourth notch respectively formed in the second upper edge and the second lower edge. The first notch and the third notch jointly form one of the two openings 11a, and the second notch and the fourth notch jointly form the other of the two openings 11a. In other embodiments of the present disclosure, in the housing 10, one of the two opening 11a extends through the first housing portion 111 and communicates with the internal space of the housing 10, while the other opening 11a extends through the second housing portion 112 and communicates with both the inner space of the housing 10 and the opening 11a in the first housing portion 111. The two openings 11a are symmetrically arranged on the housing 10 face to face.

Each opening 11a includes a first end 11a1 and a second end 11a2, and the first end 11a1 is more adjacent to the front end of the massage device 100 relative to the second end 11a2. In some embodiments of the present disclosure, the moving space and the two openings 11a are located at a portion which between the top head and the handle, especially, more adjacent to the top head.

The housing 10 for an accommodating portion 12 for accommodating the swing unit 3. A connecting portion 13 and a mounting shaft 14 for mounting the swing unit 3 in the housing are further provided inside the housing 10. The accommodating portion 12 is symmetrically disposed on inner surfaces of the first housing portion 111 and the second housing portion 112. When the first housing portion 111 and the second housing portion 112 are assembled, the two accommodating portions 12 are enclosed to define an accommodating space.

Two connecting portions 13 are symmetrically disposed on the first housing portion 111 and the second housing portion 112. The mounting shaft 14 is perpendicular to the front-rear direction, one end of the mounting shaft 14 is connected to the connecting portion 13 of the first housing portion 111, and the other end is connected to the connecting portion 13 of the second housing portion 112, so that a part of the swing unit 3 is pivoted to the housing 10 via the mounting shaft 14, and thus the swing unit 3 is swingable by rotating around the mounting shaft 14.

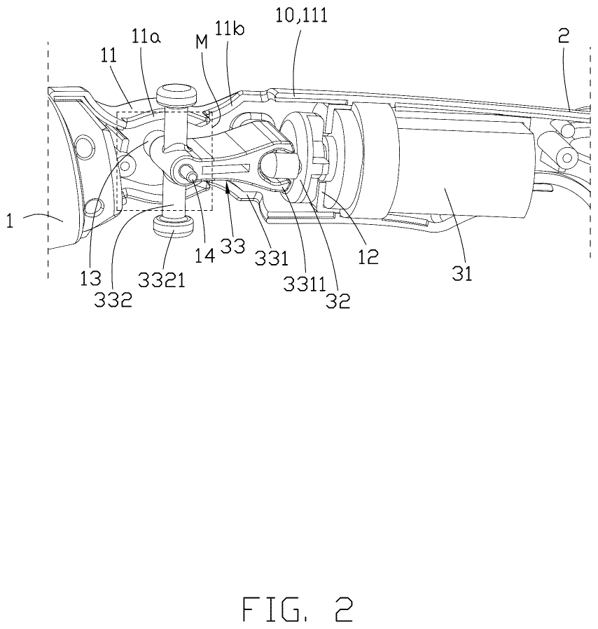

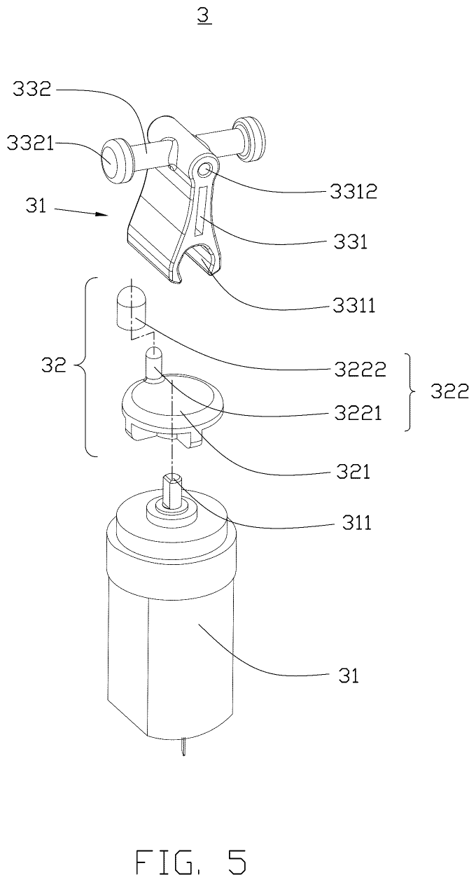

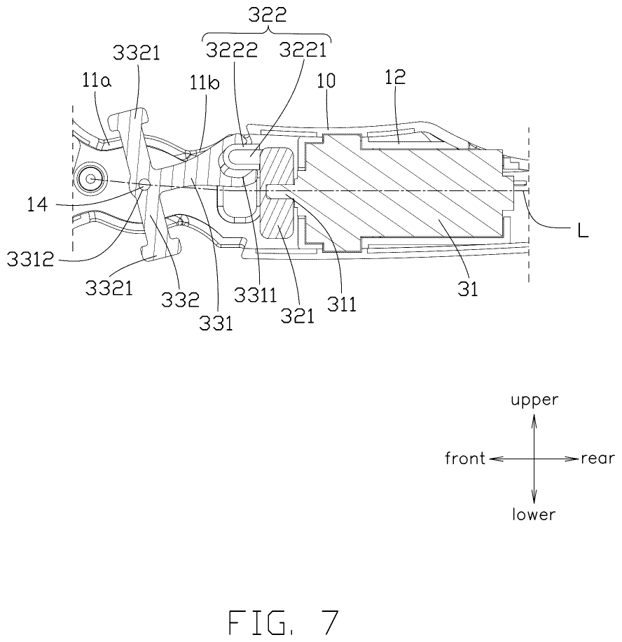

The detailed configuration of the swing unit 3 will be described below with continued references to FIG. 2 to FIG. 7.

The swing unit 3 includes a driving section 31, a transmission section 32, and a swing section 33.

The driving section 31 is used to supply power, including a motor installed in the accommodating space of the housing 10. The driving section 31 includes an output shaft 311 protruding from the accommodating space. The output shaft 311 of the driving section 31 may coincide with or be parallel to the front-rear direction. The driving section 31 may rotate continuously in one direction or alternately in opposite directions.

The transmission section 32 cooperates with the output shaft 311 to generate a force in a vertical direction perpendicular to the output shaft 311 based on rotations of the output shaft 311. The transmission section 32 is configured as an eccentric shaft structure, one end of the transmission section 32 connected to the output shaft 311 of the driving section 31 and the other end connected to the swing section 33, so that the driving section 31 drives rotations of the transmission section 32 which drive the swing section 33, and thus the swing section 33 swings back and forth along the front-rear direction of the body 10. The transmission section 32 includes a drive wheel 321. A central of a rear surface of the drive wheel 321 engages with the output shaft 311 of the driving section 31. An eccentric shaft 322 is formed by protruding from the front surface of the driving section 31 away from the driving section 31. The eccentric shaft 322 is arranged deviating from a central axis of the drive wheel 321, and includes a protrusion 3221 integrally formed with the drive wheel 321 and a covering member 3222 covering the protrusion 3221. In some embodiments of the present disclosure, the covering member 3222 is flexible.

When the driving section 31 drives, the output shaft 311 drives the transmission section 32 to rotate, the eccentric shaft 322 deviates from the central of the drive wheel 321 to perform a circular motion around the output shaft 311. The eccentric shaft 322 may protrude in parallel with a center axis of the drive wheel 321, or may protrude not in parallel. In the transmission section 32, the central axis of the drive wheel 321 may coincide with or be parallel to the axis L, so it can also be said that the eccentric shaft 322 rotates around the axis L. The covering member 3222 made of a flexible material serves as a portion in contact with the swing section 33, which is able to suppress noise generated in the swing section 33 when the eccentric shaft 322 is operated.

The swing section 33 is pivotally connected between the first housing portion 111 and the second housing portion 112 via the mounting shaft 14, an end part 332 of the swing section 33 is extendable out of the housing 10 via the openings 11a, and is swingable back and forth in an extending direction (a front-rear direction) of the housing 10. The swing section 33 includes a connecting rod 331 and a swing rod(end part) 332 intersecting with each other.

The connecting rod 331 has an elongated shape and connects to the eccentric shaft 322 and the mounting shaft 14. A pivot hole 3312 is formed through one end of the connecting rod 331, and a slot 3311 is recessed at the other end of the connecting rod 331.

The pivot hole 3312 extends through the connecting rod 331 in a direction (e.g., left-right direction as depicted) from the connecting portion 13 on the first housing portion 111 toward the connecting portion 13 on the second housing portion 112. The pivot hole 3312 is used for allowing the pivot joint shaft 14 to pass through and movably accommodating the mounting shaft 14, so that the connecting rod 331 and the swing section 33 are restricted to move along a direction (a left-right direction as depicted) perpendicular to the axis L with being rotatable around the mounting shaft 14. In addition, preferably, the massage device 100 further includes a buffering member 5 located between the mounting shaft 14 and the pivot hole 3312 and sleeved on the mounting shaft 14. The buffering member 5 may be formed of a flexible material and configured to dampen the noise generated by the mounting shaft 14 when the swing section 33 operates.

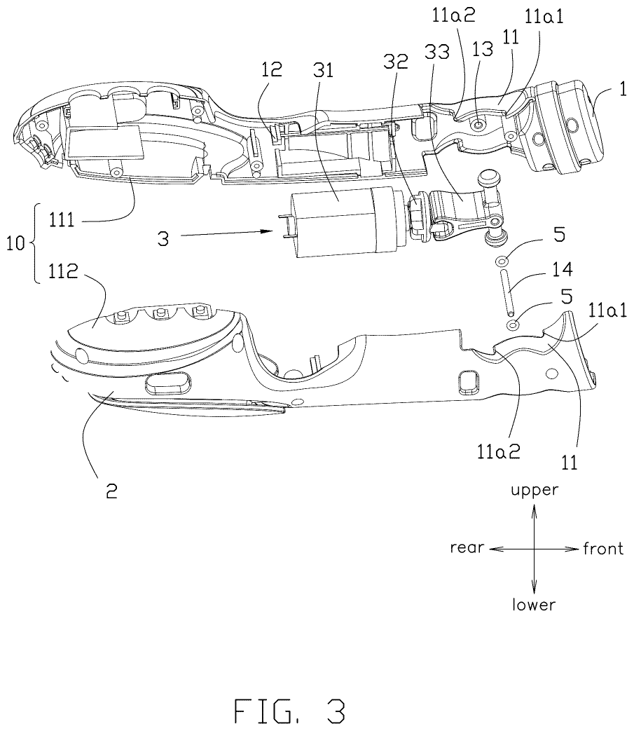

The slot 3311 is recessed towards a direction away from the eccentric shaft 322 (i.e. the forward direction of FIG. 3). When viewed from a side, the cross section of the slot 3311 is a semi-circular structure including an upper interior wall and a lower interior wall. The eccentric shaft 322 of the transmission section 32 is inserted into the slot 3311, and the transmission section 32 drives the swing section 33 by engaging with the slot 3311. When the eccentric shaft 322 is displaced in the upward direction, it abuts against the upper interior wall of the slot 3311 to actuate an upward movement of a rear end portion of the connecting rod 331 where the slot 3311 is formed.

Conversely, when the eccentric shaft 322 is displaced in the downward direction, it abuts against the lower interior wall of the slot 3311 to actuate a downward movement of the rear end portion. The connecting rod 331 is constrained to pivot about the mounting shaft 14, thereby enabling the eccentric shaft 322 to push the swing section 33 in the up-down direction perpendicular to the output shaft 311 (the axis L), thus causing the swing section 33 to rotate about the mounting shaft 14 by being pushed by the transmission section 32.

Further, the connection manner between the connecting rod 331 and the main body 10 is not limited to the manner described above, and it can be understood that any existing pivoting structure can be applied. For example, the mounting shaft 14 is fixedly connected to or integrally formed with either the first housing portion 111 or the second housing portion 112, and passes through the pivot hole 3312 of the connecting rod 331; the mounting shaft 14 is fixedly connected to or integrally formed with the connecting rod 331, extends towards the connecting portion 13 provided on the first housing portion 111 and the second housing portion 112, and is pivotally connected to the connecting portion 13 of the housing 10; The mounting shafts 14 are respectively disposed on the connecting portions 13 of the first housing portion 111 and the second housing portion 112, and pass through the pivot holes 312 of the connecting rods 331. Further, the position of the buffering member 5 can be appropriately changed according to the arrangement form of the mounting shaft 14.

The swing rod 332 is disposed at a position where is close to the pivot hole 3312 of the connecting rod 331, and is perpendicularly protrudes from one end of the connecting rod 331, i.e. the protruding direction of the swing rod 332 is perpendicular to the extending direction of the housing 10. The swing rod 332 is connected to the connecting rod 331, and the swing rod 332 and the connecting rod 331 rotate coaxially. Preferably, the swing portion 33 is integrally formed, that is, the swing rod 332 and the connecting rod 331 are integrally formed. The swing rod 332 extends from a side of the connecting rod 331 close to the pivot hole 3312 to the outside of the housing 10 through the opening 11a. An end portion 3321 is slightly higher than the outer circumferential surface of the housing 100. The swing rod 332 may extend in either direction that intersects the mounting shaft 14 and that intersects the axis L. When the driving section 31 drives, the swing rod 332 swings back and forth between the first end 11a1 and the second end 11a2 of the opening 11a at a position different from that of the connecting rod 331. Preferably, a flange is formed at a free end 332 which protrudes outside the housing 10, the flange comprising an elastic material. In addition, the present disclosure is not limited to the above embodiments, and the end portion 3321 may be flush with the outer circumferential surface of the housing 100 where the openings is not defined, as long as it is higher than a curved edge 11 of the openings.

In this embodiment, the massage device 100 further includes a battery (not shown) and a control circuit (not shown).

Furthermore, since the covering material covers the housing 10 together with the end portion 3321 of the swing rod 332, in order to avoid scratching the covering material when the swing rod 332 moves, the curved edge 11 is preferably formed around the opening 11a. In a side view, the curved edges 11 are gradually inward from the first end 11a1 and the second end 11a2 to the center of the opening 11a. As a result, the curved edge 11 is curved so as to reduce or eliminate a change in the height at which the covering material is stretched by the swing rod 332, thereby effectively suppressing breakage of the covering material.

Further, when the curved edge 11 is concaved toward the axis L, that is, toward the inside of the housing 10, to a movable range of the swing unit 3, the housing 10 may include a hole 11b formed to avoid interference with the connecting rod 331 of the swing portion 33, as exemplary of swing unit 3. As long as the hole 11b is used for avoiding interfering the swing unit 3, the position and size of the hole 11b are appropriately set. For example, in the example of the present embodiment, the hole 11b communicates with the opening 11a and penetrates toward the rear end 2 of the housing 10. However, it should be understood that the hole 11b may not be communicated with the opening 11a as long as the hole 11b can provide clearance for the swing unit 3. When the connecting rod 331 is rotated beyond the movement range of the housing 10, the hole 11b is provided to avoid the connecting rod 331, which may avoid interference.

Furthermore, two or more sets of the openings 11a, the holes 11b and the swing rod 332 can be provided.

Furthermore, the structures of the connecting rod 331 and the transmission section 32 can be changed as appropriate, so that the connecting rod 331 can drive the transmission section 32 to make the first swinging end 3321 and the second swinging end 3321 swing back and forth relative to the housing 10 along the extending direction of the housing 10, and the first swinging end 3321 and the second swinging end 3321 swing alternatively.

Furthermore, the housing 10 also includes an interface port 4 for connecting with other function modules (not shown), so that the massage device 100 has more functions.

An upper end portion of the swing rod 332 is hereinafter described as a first swing end 3321 and a lower end portion of the swing rod 332 is hereinafter described as a second swing end 3321. During use of the massage device 100, When the driving section 31 drives, the output shaft 311 drives the transmission section 32 to rotate, and at the same time, the eccentric shaft 322 deviates from the central of the drive wheel 321 to perform a circular motion around the output shaft 311. When the eccentric shaft 322 is displaced in the upward direction, it abuts against an upper interior wall of the actuation slot 3311 to actuate upward movement of a rear end portion of the connecting rod 331 where the slot 3311 is formed, the first swing end 3321 of the swing rod 332 moves towards the front side of the housing 10, while the second swing end 3321 of the swing rod 332 moves towards the rear side of the housing 10; when the eccentric shaft 322 is displaced in the downward direction, it abuts against the lower interior wall of the slot 3311 to actuate downward movement of the rear end portion, the first swing end 3321 of the swing rod 332 moves towards the rear side of the housing 10, while the second swing end 3321 of the swing rod 332 moves towards the front side of the housing 10; thus the first swing end 3321 of the swing rod 332 and the second swing end 3321 of the swing rod 332 protrude from the openings 11a and swing back and forth along the extension direction of the housing 10.

In the present embodiment, the outer side walls of the housing 10 and the swing rod 332 are sheathed with a covering member 3222. The covering member 3222 includes a main body, a recess portion and a massage protrusion. The main body of the covering member 3222 is shielded on the outer side wall of the housing 10, the recess portion is located opposite to the openings 11a so as to cover the openings 11a, the massage protrusion laterally protrudes from a bottom surface of the recess part, and the first swing end part 3321 is inserted into the massage protrusion via the opening 11a.

When the massaging device is used, the housing 10 is inserted into the female's vagina, an outer surface of the massaging protrusion of the covering member 3222 directly contacts an inner wall of the vagina, and the outer surface of the massaging protrusion is driven by the swing rod 332 to beat and soothe the inner wall of the vagina, thereby stimulating and massaging the female's vagina. According to the present disclosure, the massage device 100 capable of realizing a driving mode in which the driving module 100 can reciprocate in the front-rear direction of the housing 10, and is capable of being miniaturized and has a compact structure.

### Embodiment 2

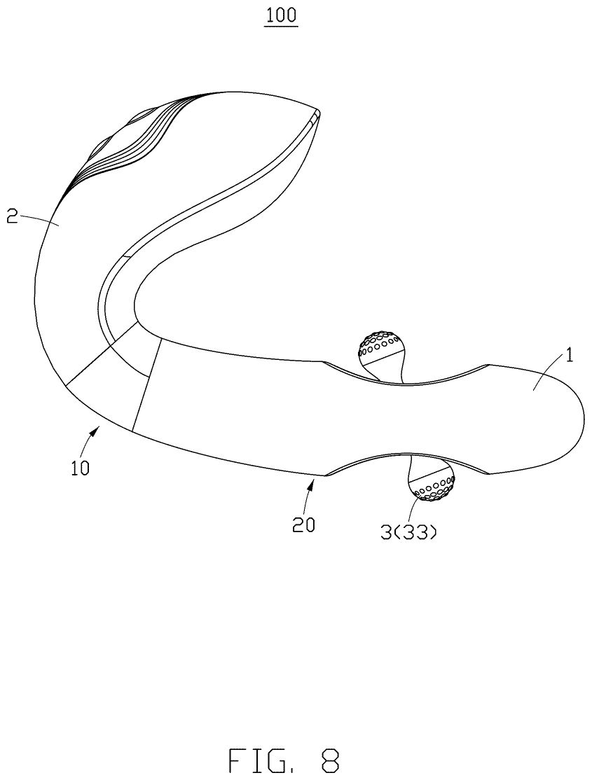

Referring to FIG. 8 to FIG. 10, Embodiment 2 differs from Embodiment 1 in that: the housing 10 is in a hook shape and the swing unit 3 has a different structure and a different driving manner of. Specifically, the housing 10 has an exterior portion and an insertable portion connecting with the exterior portion. The, insertable portion is insertable into the vagina, the exterior portion 2 is bent toward the insertable portion. The exterior portion 2 is located outside the human body and is in contact with the female clitoris when the insertable portion is inserted into the vagina, so that a user can irritate the female clitoris while holding the exterior portion 2. In the present embodiment, the exterior portion 2 of the housing 10 may also be internally provided with a vibration motor for generating vibration, so as to stimulate the clitoris and achieve the effect of massaging.

The swing unit 3 is attached to the insertable portion 20 of the housing 10, and a part thereof is exposed to the outside of the insertable portion 20 through an opening 11a. The swing unit 3 includes a driving section 31, a transmission section 32, and a swing section 33. The driving section 31 is fixedly installed in the insertable portion 20. The structure of the driving section 31 is the same as that in Embodiment 1, and is not repeated herein. In the second embodiment, the transmission section 32 includes a reduction gear assembly 321′ and a bent shaft 322′, one end of the reduction gear assembly 321′ is connected to the output shaft 311 of the driving section 31, and the other end is connected to one end of the bent shaft 322′, so that the rotation of the output shaft 311 is transmitted to the bent shaft 322′ after being decelerated by the reduction gear assembly 321′. The bent shaft 322′ includes a first shaft part 3221′ which is parallel to the output shaft of the driving section 21 and a second shaft part 3222′ connected to the first shaft part 3221′ and forming an obtuse angle between the first shaft part 3221′ and the second shaft part 3222′. One end of the first shaft part 3221′ is connected to the reduction gear assembly 321′, and the second shaft part 3222′ is formed by bending and obliquely extending from an end of the first shaft part 3221′ away from the reduction gear assembly 321′, and is perpendicularly connected to the swing rod 332′ of the swing section 33.

In the second embodiment, the swing section 33 does not include a connecting rod 331, two ends of the swing section 33 are provided with the swing ends 3321, the second shaft part 3222′ is inserted into a middle of the swing section 33, so that the second shaft part 3222′ of the swing section 33 drives the swinging rod 332′ to swing.

Under the drive of the driving section 31 and the speed reduction gear assembly 321′, the first shaft part 3221′ rotates around itself, so that the second shaft part 3222′ rotates around the extension line of the first shaft part 3221′ with an angle. Since the second shaft part 3222′ is obliquely arranged relative to the first shaft part 3221′, and the second shaft part 3222′ drives the swing section 33 to move, at this time, one swing end 3321 of the swing section 33 swings close to the front end 1 of the housing 10 and the other swing end 3321 of the swing part 33 swings away from the front end 1 of the main body 10, so that the swing ends 3321 reciprocate in the extending direction (the front-back direction) of the housing 10, and the two swing end 332 of the swing section 33 realize the massaging effect of the seesaw.

Outer sidewalls of both swing ends 3321 of the swing section 33 and an outer sidewall of the insertable portion 20 are fitted with the covering member 3222 of the Embodiment 1.

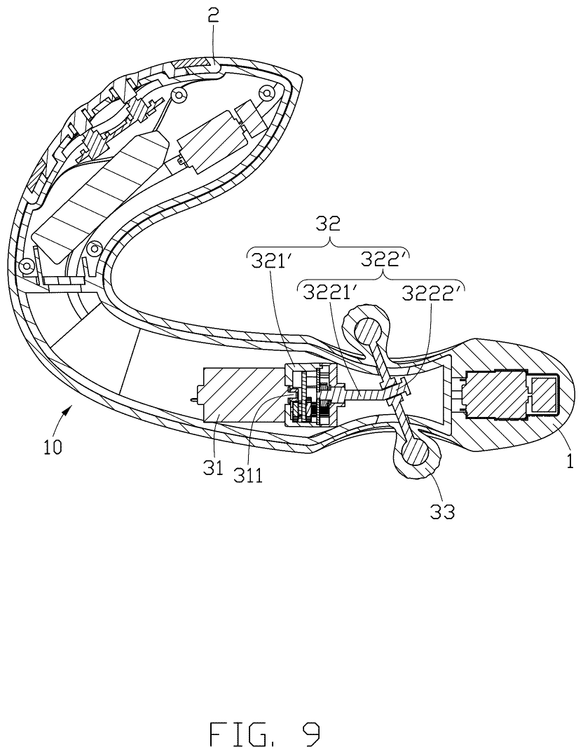

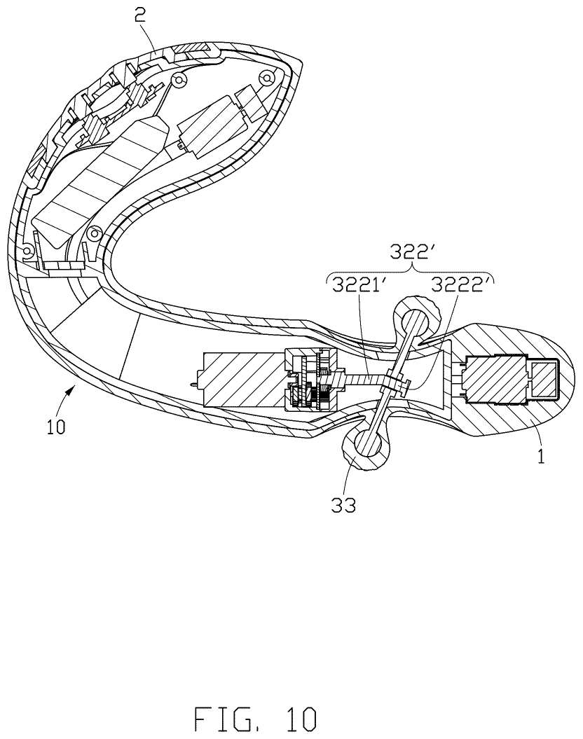

It can be understood that the rotation track of the second shaft part 3222′ forms a conical surface, and the movement track of the end of the second shaft part 3222′ forms a circle. As a result, as shown in FIG. 9, the trajectory of movement of the end of the swing rod 332′ perpendicular to the swing section 33 is elliptic, and the end of the swing rod 332′ can swing back and forth between the two positions shown in FIGS. 9 and 10. According to the present embodiment, the massage device 100 capable of realizing a driving mode in which the massage device 100 reciprocates along an elliptic trajectory, whereby the massage device capable of being miniaturized and having a compact structure can be provided.

### Embodiment 3

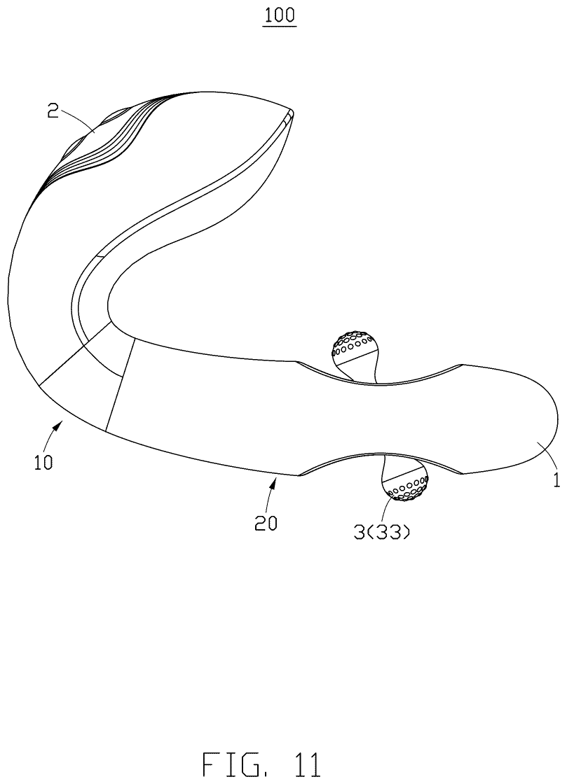

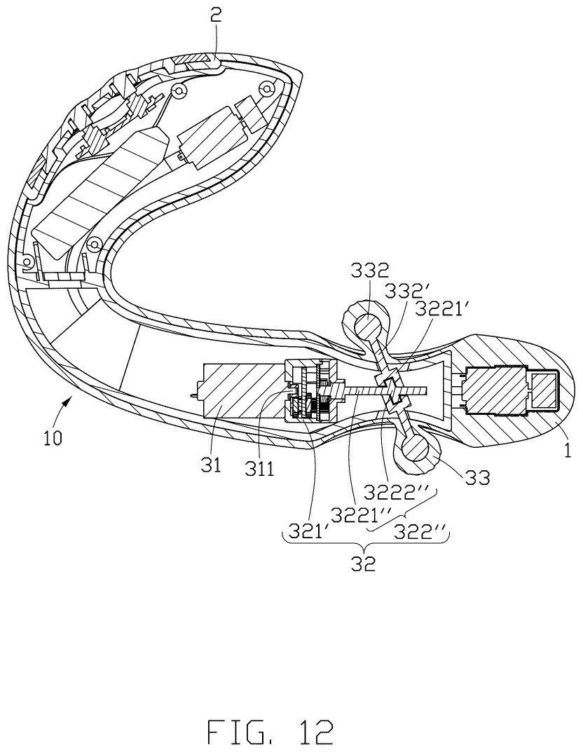

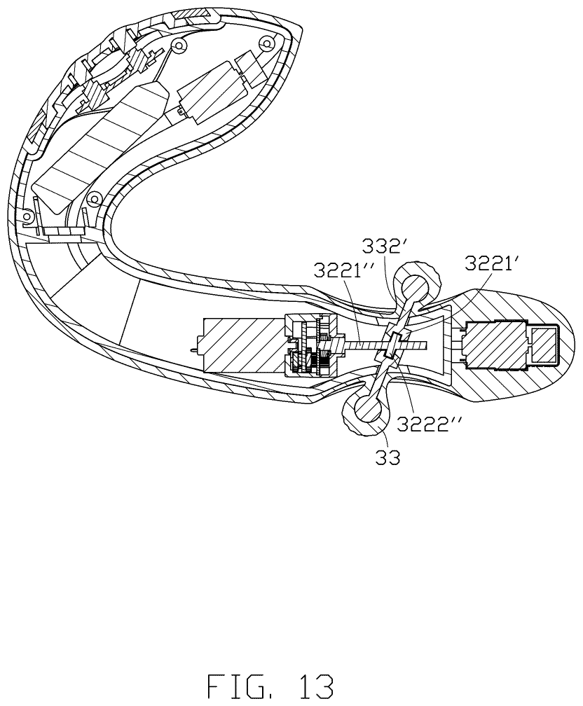

Referring to FIGS. 11-13, the third embodiment differs from the second embodiment in that: the transmission part 32 includes a reduction gear assembly 321′ and a rotation shaft 322″, and the rotation shaft 322″ includes a main shaft 3221″ disposed parallel to the output shaft of the driving section and a flange 3222″ arranged at a middle of the main shaft 3221″ and laterally protruding from the main shaft 3221″. The main shaft 3221″ is in an elongated rod shape, the flange 3222″ is in a block shape, and the flange 3222″ may be a plate obliquely arranged relative to the main shaft 3221″, i.e. the main shaft 3221″ and a plane where the flange 3222″ is located form an acute angle or an obtuse angle. The middle part of the swing rod 332′ of the swing section 33 is provided with a recess 3321′ which engages with the flange 3222″ and is connected to the flange 3222″, and the recess 3321′ is further provided with a through hole through which the main shaft 3221″ penetrates. The length direction of the swing rod 332′ is parallel to the plane where the flange 3222″ is located, and therefore the main shaft 3221″ is also inclined to the swing rod 332′. Thus, when the main shaft 3221′ rotates, the trajectory of the movement of the end of the swing rod 332′ is elliptical, and the end of the swing rod 332′ can swing back and forth between the two positions shown in FIGS. 12 and 13. Outer sidewalls of both swing ends 3321 of the swing section 33 and an outer sidewall of the insertable portion 20 are fitted with the covering member 3222 of the Embodiment 1.

According to the present embodiment, there is provided the massage device 100 capable of realizing a driving mode in which the massage device 100 reciprocates along an elliptic trajectory, whereby the massage device capable of being miniaturized and having a compact structure can be provided.

### Embodiment 4

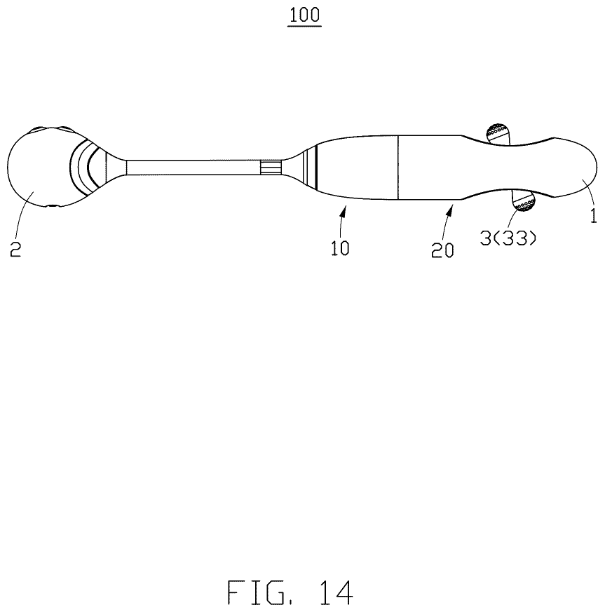

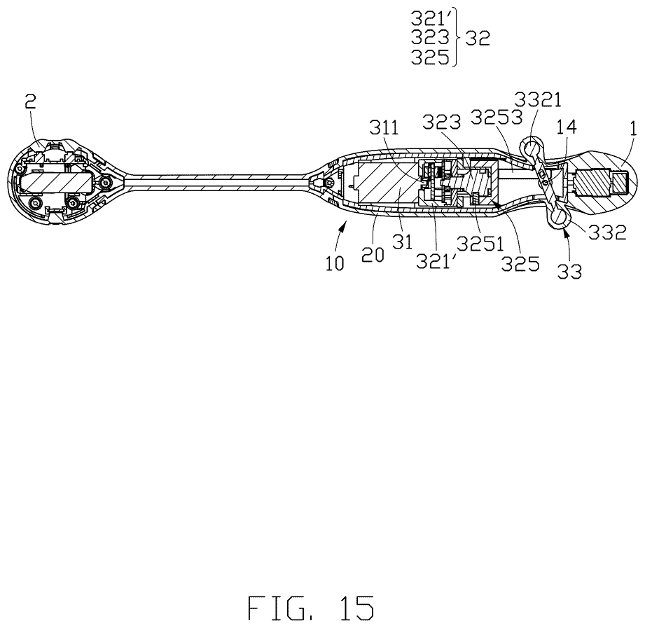

Referring to FIG. 14 to FIG. 15, Embodiment 4 differs from Embodiment 1 in that: the shape of the housing 10 is different, and the specific structure and driving manner of the swing unit 3 are different. Specifically, the housing 10 extends in an elongated strip shape and is connected between the driving portion 31 and the rear end 2 of the housing 10 by an elongated rod, and the rear end 2 of the housing 10 is formed as a spherical portion. A vibration unit is provided in the front end 1 of the housing 10. The swing unit 3 is mounted in the housing 10, and includes a driving section 31, a transmission section 32, and a swing section 33. The structure of the driving section 31 is the same as that in the Embodiment 1, and is not further described herein. In the Embodiment 4, the transmission section 32 includes a reduction gear assembly 321′, a screw 323 and a slider 325. One end of the reduction gear assembly 321′ is connected to the output shaft 311 of the driving section 31, and the other end is connected to the screw 323, so that the power of the rotation of the output shaft 311 is transmitted to the screw 323 after being decelerated by the reduction gear assembly 321′. A helical groove is provided on the outer periphery of the screw 323, the slider 325 is sheathed on the screw 323, a pin 3251 protrudes from an inner side of the slider 325 towards the screw 323, and inserts into the helical groove. Thus, the rotation of the screw 323 can drive the pin 3251 and the slider 325 to move back and forth along the extending direction of the housing 10. The slider 325 is provided with a push rod 3253 extending toward the swing section 332 of the swinging section 33.

The swing section 33 is rotatably mounted on the mounting shaft 14 of the insertable portion 20, the push rod 3253 is rotatably connected to the swing section 33, and a connecting point of the push rod 3253 and the swing section 33 is spaced apart from the mounting shaft 14. Thus, the slider 325 and the push rod 3253 perform reciprocal telescopic motions along the extending direction of the housing 10, so as to drive the swinging section 33 to perform reciprocal swinging motions around the mounting shaft 14 along the extending direction of the main body 10, and the first swinging end portion 3321 and the second swinging end portion 3321 of the swinging section 33 swing in opposite directions. It may be appreciated that the swing section 33 may be provided with only the first swing end 3321 through one side of the housing 10 without providing the second swing end 3321 through the other side of the housing 10. Outer sidewalls of both swing ends 3321 of the swing section 33 and an outer sidewall of the insertable portion 20 are fitted with the covering member 3222 of the embodiment 1.

According to the present embodiment, there is provided the massage device 100 capable of realizing a driving mode in which the massage device 100 can reciprocate in the front-rear direction of the housing 10, whereby it is possible to provide the massage device capable of being miniaturized and having a compact structure.

### Embodiment 5

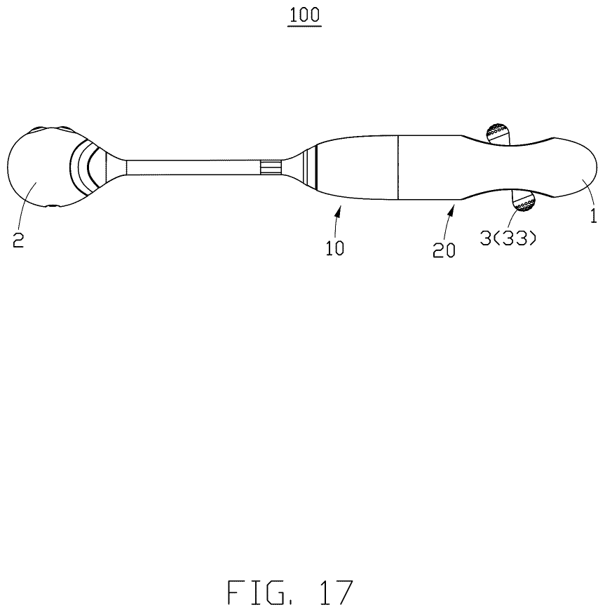

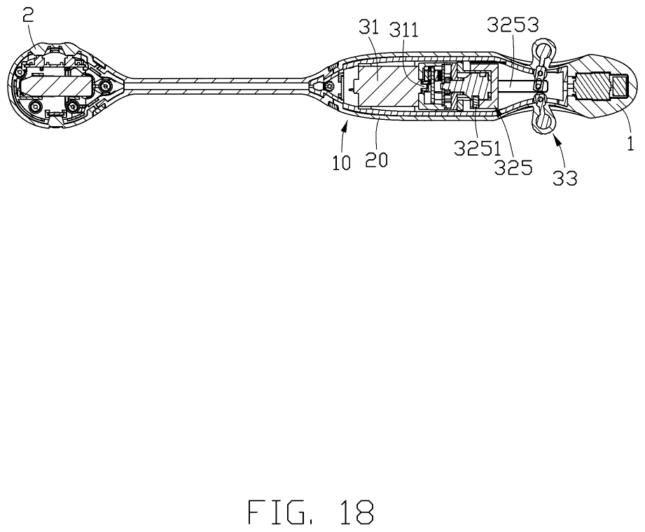

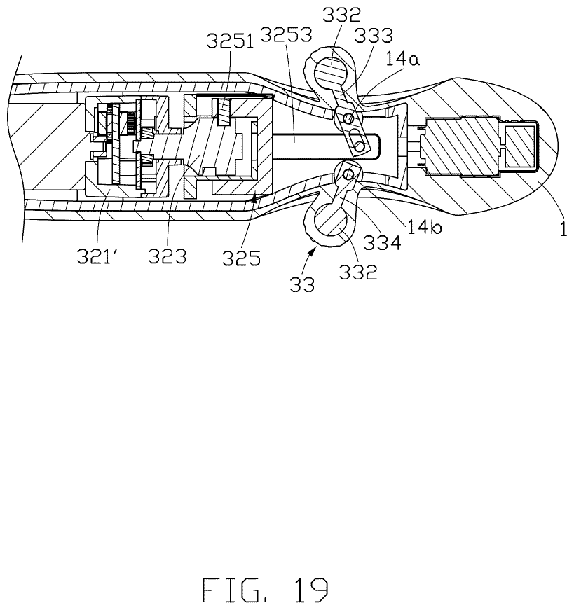

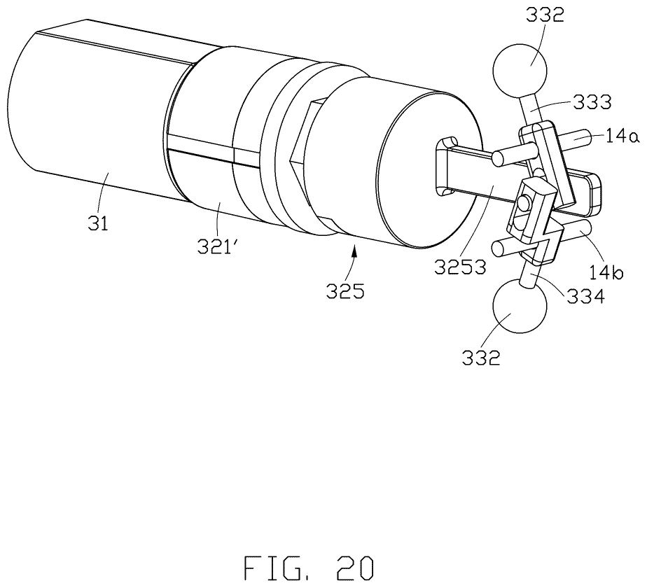

Referring to FIGS. 17-20, the fifth embodiment differs from the Embodiment 4 in that: the swing rod 332 of the swing section 33 is not integrally formed, but includes a first swing rod 333 and a second swing rod 334 which are separately provided. The first swing rod 333 at least partially overlaps the second swing rod 334. The first swing rod 333 and the second swing rod 334 are respectively rotatably mounted on the first mounting shaft 14a and the second mounting shaft 14b, the push rod 3253 is rotatably connected to the overlapping part of the first swing rod 333 and the second swing rod 334, and the connecting points of the push rod 3253 with the first swing rod 333 and the second swing rod 334 are spaced from the first mounting shaft 14a and the second mounting shaft 14b. Thus, the slider 325 and the push rod 3253 perform reciprocal telescopic movements along the extending direction of the housing 10, thereby driving the first swing rod 333 and the second swing rod 334 to respectively perform reciprocal swinging movements around the first mounting shaft 14a and the second mounting shaft 14b along the extending direction of the housing 10. Furthermore, the first swing rod 333 and the second swing rod 334 swing in the same direction at a same time, i.e. reciprocating in such a manner that the first swing rod 333 and the second swing rod 334 synchronously approach the front end 1 of the housing 10 and synchronously move away from the front end 1 of the housing 10. As a result, the swing ends 332 of the first and second swing rods 333 and 334 swing back and forth in the extending direction (front-rear direction) of the housing 10. It may be appreciated that the swing section 33 may be provided with only the first swing rod 333 through one side of the housing 10 without providing the second swing rod 334 through the other side of the housing 10.

According to the present embodiment, there is provided the massage device 100 capable of realizing the massage device in which the massage device 100 can reciprocate in the front-rear direction of the housing 10, whereby it is possible to provide the massage device capable of being miniaturized and having a compact structure. Outer sidewalls of both swing ends 3321 of the swing section 33 and an outer sidewall of the housing 10 are fitted with the covering member 3222 of the Embodiment 1.

### Embodiment 6

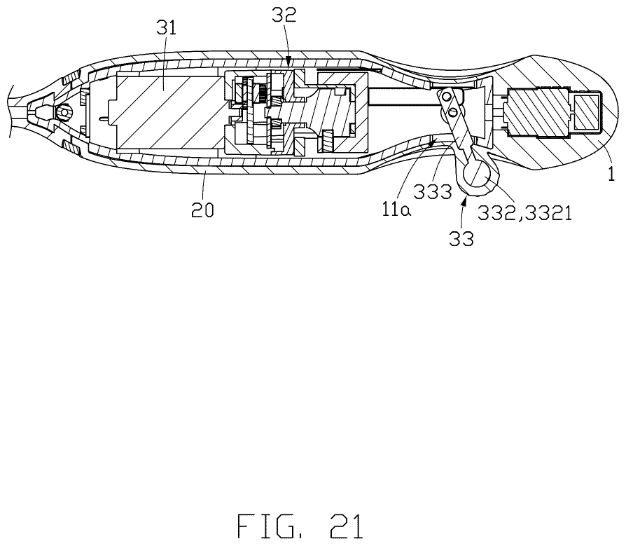

Referring to FIG. 21, Embodiment 6 differs from Embodiment 4 in that: the swing section 33 includes one swing rod 333, thus, the swing rod 333 is exposed to the outside of the housing 10 through an opening 11a. That is, only one side of the housing has an opening, and the opposite side is sealed, so that one side wall of the housing forms a groove with the one opening 11a, the driving section 31, the transmission section 32 and the swing section 33 are installed in the groove. In this embodiment, the swing rod 333 swings along the length direction of the housing 10.

An outer sidewall of a swing end 3321 of the swing section 33 and an outer sidewall of the housing 10 are fitted with the covering member 3222 of the Embodiment 1.

The foregoing description is merely a detailed embodiment of the present disclosure, but the scope of protection of the present disclosure is not limited thereto. Any people skilled in the art would be able to make equivalent replacements or changes within the technical scope disclosed by the present disclosure, and all should be covered within the scope of protection of the present disclosure. Therefore, the scope of protection of the present disclosure should be subject to the scope of protection of the claims.

What is claimed is:

1. A massage device, being a sexual massage device for massaging vagina or anus, comprising:
a housing comprising a surrounding wall forming a cylindrical structure and two opposite openings respectively passing through the surrounding wall on opposite sides of the housing, and
a swing unit, accommodated in the housing and comprising:
a motor including an output shaft parallel to a center line of the motor;
a swing section comprising at least one swing rod mounted on the output shaft of the motor via a transmission member which has a configuration such that the at least one swing rod is arranged non-parallel to the output shaft, the at least one swing rod comprising a first swing end and a second swing end, the first and the second swing ends respectively connected to two opposite ends of the swing rod and protruding from the two openings to outside of the housing respectively;
and
a transmission section, connected between the output shaft of the motor and the at least one swing rod;
wherein the transmission section is further configured to convert a rotational motion of the motor into a swing motion of the at least one swing rod, the at least one swing rod swings back and forth with respect to a pivot point on the extension line of the output shaft, and the first swing end and the second swing end swing back and forth with respect to the housing.

2. The massage device according to claim 1, wherein
the swing section is further pivoted to the housing via a first mounting shaft, and is movably connected to the transmission section, and a portion of the swing section which is pivoted to the housing through the first mounting shaft is away from the transmission section.

3. The massage device according to claim 2, wherein
the swing unit further comprises
a connecting rod, an end of the connecting rod being movably connected to the transmission section, and the other end thereof of the connecting rod away from the transmission section being pivoted to the housing via the first mounting shaft; and
the swing rod is connected to the connecting rod in an intersecting manner, and extends from a position in the swing unit close to the first mounting shaft towards the outside of the opening to form the first swing end and the second swing end.

4. The massage device according to claim 2, wherein
the transmission section comprises an eccentric shaft, the eccentric shaft extends towards a side away from the output shaft and deviates from the output shaft, the eccentric shaft rotates around the output shaft, and pushes the at least one swing section in a direction perpendicular to a length direction of the output shaft.

5. The massage device according to claim 4, wherein
an actuation slot is formed at one end of the connecting rod close to the transmission section, the actuation slot is recessed towards a side away from the transmission section, and the actuation slot abuts against the eccentric shaft, so that the connecting rod is driven to rotate around the first mounting shaft by the eccentric shaft.

6. The massage device according to claim 3, wherein
the opening passes through from a first end to a second end along an extending direction of the housing,
the first swing end and the second swing end of the swing rod swing back and forth between the first end and the second end.

7. The massage device according to claim 1, wherein
a hole is further formed through the housing at a position close to the two openings, and the hole is in communication with the two openings, so as to prevent the swing section from contacting the housing during movement of the swing section.

8. The massage device according to claim 1, wherein
The first swing end and the second swing end are configured to be flanges made of an elastic material.

9. The massage device according to claim 1, wherein
further comprising a flexible covering member, covering the housing and end portions of the swing unit together.

10. The massage device according to claim 1, wherein
the first swing end moves towards a rear side of the housing, while the second swing end moves towards a front side of the housing; or
the first swing end moves towards the front side of the housing, while the second swing end moves towards the rear side of the housing.

11. The massage device according to claim 10, wherein
the transmission section comprises a bent portion connected to the output shaft and formed by bending outward from the output shaft so as to form an acute angle with the extension line of the output shaft, the at least one swing rod is directly mounted at the bent portion, and after assembly, the at least one swing rod is arranged obliquely to the extension line of the output shaft.

12. The massage device according to claim 10, wherein:
the transmission section comprises:
a main shaft, and
a flange protruding radially from the main shaft at an acute or obtuse angle; and
the flange engages with the swing section to generate elliptical motion of the first swing end and the second swing end.

13. The massage device according to claim 12, wherein:
the flange is a plate structure tilted to the main shaft.

14. The massage device according to claim 2, wherein:
the transmission section comprises:
a reduction gear assembly,
a screw with helical grooves, and
a slider sheathed on the screw, having a pin engaged in the helical grooves,
wherein one end of the reduction gear assembly is connected to the output shaft of the motor, and the other end is connected to the screw,
the slider comprises a push rod extending toward the at least one swing rod, the push rod is rotatably connected to the at least one swing rod, and a connecting point of the push rod and the at least one swing rod is spaced apart from the first mounting shaft.

15. The massage device according to claim 14, wherein;
the first and the second swing ends are connected to two ends of one swing rod respectively,
the rotation of the screw drives the pin and the slider to move back and forth along the extending direction of the housing, and the push rod drives the swinging section to perform reciprocal swinging motions around the first mounting shaft.

16. The massage device according to claim 15, wherein:
the at least one swing rod comprises a first swing rod and a second swing rod which are separately provided, a second mounting shaft is further provided in the housing,
the first swing rod and the second swing rod are respectively rotatably mounted on the first mounting shaft and the second mounting shaft, the push rod is rotatably connected to the first swing rod and the second swing rod.
the push rod simultaneously drives both swing rods swinging back and forth synchronously at the same direction.

17. The massage device according to claim 16, wherein:
the first swing rod at least partially overlaps the second swing rod,
the push rod is rotatably connected to the overlapping part of the first swing rod and the second swing rod, and
the first swing rod and the second swing rod synchronously swing in the same direction.

18. A massage device, being a sexual massage device for massaging vagina or anus, comprising:
a housing comprising two opposite openings respectively at opposite sides of the housing, and
a swing unit, accommodated in the housing and comprising:
a motor including an output shaft parallel to a center line of the motor;
a swing section comprising at least one swing rod mounted on the output shaft of the motor via a transmission member which has a configuration such that the at least one swing rod is arranged non-parallel to the output shaft, a first swing end and a second swing end, the first and the second swing ends respectively connected to two opposite ends of the at least one swing rod and protruding from the two openings to outside of the housing respectively; and
a transmission section, coupled between the drive section and the swing section for synchronously actuating the swing rod swing back and forth about a pivot point on an extension line of the output shaft, the first swing end and the second swing end swing back and forth with respect to the housing along an extending direction of the housing.

19. The massage device according to claim 18, wherein:
the first and the second swing ends are connected to two ends of one of the at least one swing rod
the first and the second swing ends swing back and forth synchronously at opposite directions.

20. The massage device according to claim 19, wherein:
the at least one swing rod comprises a first and a second swing rods, the first and the second swing ends are connected to ends of the first swing rod and the second swing rod respectively,
the first swing rod and the second swing rod swing back and forth synchronously at the same direction.
